(19) United States
(12) Patent Application Publication
(10) Pub. No.: US 2026/0088567 A1
(43) Pub. Date: Mar. 26, 2026

(54) FLOATING MECHANISM FOR ALIGNED MATE OF ELECTRICAL CONNECTORS

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: KUO-CHUN HSU, New Taipei (TW)

(21) Appl. No.: 19/324,497

(22) Filed: Sep. 10, 2025

Related U.S. Application Data
(60) Provisional application No. 63/697,036, filed on Sep. 20, 2024.

(51) Int. Cl. H01R 13/631

(52) U.S. Cl. CPC H01R 13/6315

(57) ABSTRACT

A floating mechanism includes: a receiving cavity and plural caves defined in a device; and a frame fitly retained with a plug connector defining a mating direction and pushed to move forwards in the mating direction by a spring member located behind the frame, wherein the frame has guiding rods, each of the caves has a conical inside, and the guiding rods are capable of shifting along corresponding conical insides of the caves.

### CROSS REFERENCE TO RELATED APPLICATION

This application claims priority to and benefit of U.S. Provisional Ser. No. 63/697,036 , filed on Sep. 20, 2024, and this application is also a Continuation-In-Part of U.S. patent application Ser. No. 19/238,714, filed on Jun. 16, 2025, which claims priority to U.S. Provisional Ser. No. 63/686,410 , filed on Aug. 23, 2024, all of which are incorporated herein by reference in their entirety.

### BACKGROUND OF THE INVENTION

### Field of the Invention

The present invention relates to a floating and centering mechanism for aligned mating of two mating electrical connectors.

### Description of Related Arts

U.S. Patent Application Publication No. 2023/0187861 discloses a dense, high speed interconnection formed with a header connector and a mating receptacle connector. The header connector includes structural projections and the receptacle connector includes corresponding apertures receiving the structural projections in order to reduce damage to contact portions of the header connector.

U.S. Patent Application Publication No. 2024/0195116 disclose a connector assembly includes a connector holder having a frame including an upper frame member, a lower frame member, and first and second side frame members defining a connector chamber. The frame includes a rear frame member rearward of the connector chamber. The connector assembly includes a cable connector received in the connector chamber having a connector housing holding contact assemblies. The connector assembly includes a biasing member operably coupled between the cable connector and the rear frame member of the connector holder. The biasing member forward biases the cable connector and is compressible in a rearward compression direction to allow the cable connector to move rearward relative to the rear frame member.

Therefore, an improved floating mechanism is desired to overcome the disadvantages of the prior arts.

### SUMMARY OF THE INVENTION

An object of the present invention is to provide a floating mechanism.

In order to achieve above-mentioned object, a floating mechanism comprises: a receiving cavity and plural caves defined in a device; and a frame fitly retained with a plug connector defining a mating direction and pushed to move forwards in the mating direction by a spring member located behind the frame, wherein the frame has guiding rods, each of the caves has a conical inside, and the guiding rods are capable of shifting along corresponding conical insides of the caves.

Other objects, advantages and novel features of the present invention will become more apparent from the following detailed description of the present embodiment when taken in conjunction with the accompanying drawings.

### BRIEF DESCRIPTION OF DRAWINGS

FIG. 1 is a perspective view of a mechanism retained in a cartridge according to an embodiment of the present invention;

FIG. 2 is a cross-sectional view taken along line A-A in FIG. 1;

FIG. 3 is a cross-sectional view taken along line B-B in FIG. 1;

FIG. 4 is a cross-sectional view taken along line C-C in FIG. 1;

FIG. 5 is a front and top exploded perspective view of FIG. 1;

FIG. 6 is a rear and top exploded perspective view of FIG. 1;

FIG. 7 is a perspective view of a top base in FIG. 5;

FIG. 8 is a perspective view of a bottom base in FIG. 5;

FIG. 9 is a top plan view of the mechanism in FIG. 6;

FIG. 10 is a front and top exploded perspective view of the mechanism of FIG. 9;

FIG. 11 is a rear and top exploded perspective view of FIG. 9; and

FIG. 12 is an exploded perspective view of the spring member of FIG. 11.

### DETAILED DESCRIPTION OF THE DRAWINGS

Reference will now be made to the drawing figures to describe the preferred embodiment of the present invention in detail.

The invention is related to a floating and centering mating mechanism for precisely positioning in order to align a plug connector and a receptacle connector. The plug connector and the receptacle connector can be illustrated in U.S. patent application Ser. No. 19/238,714.

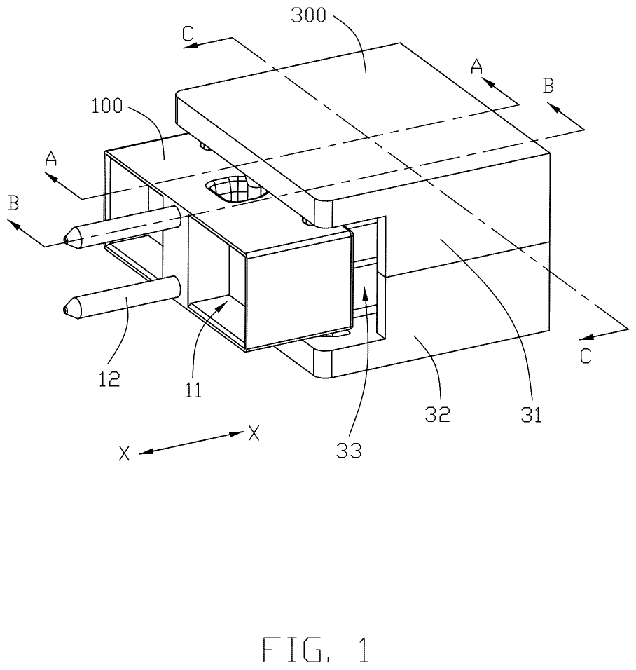

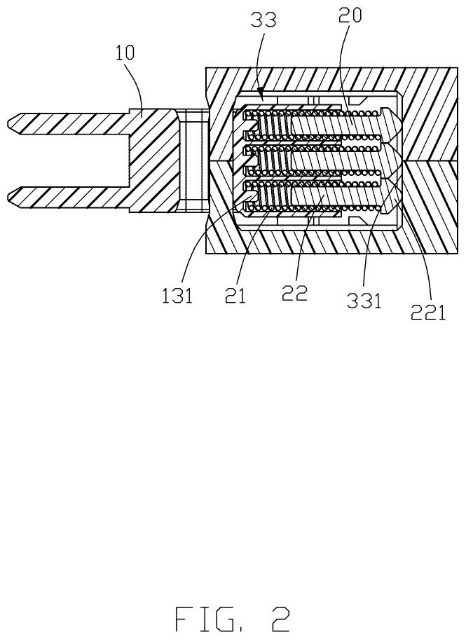

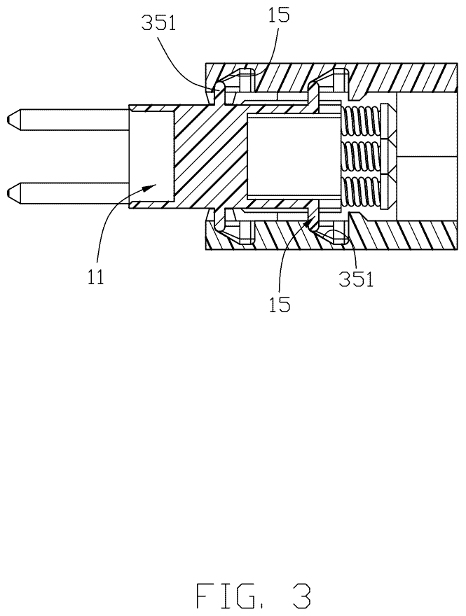

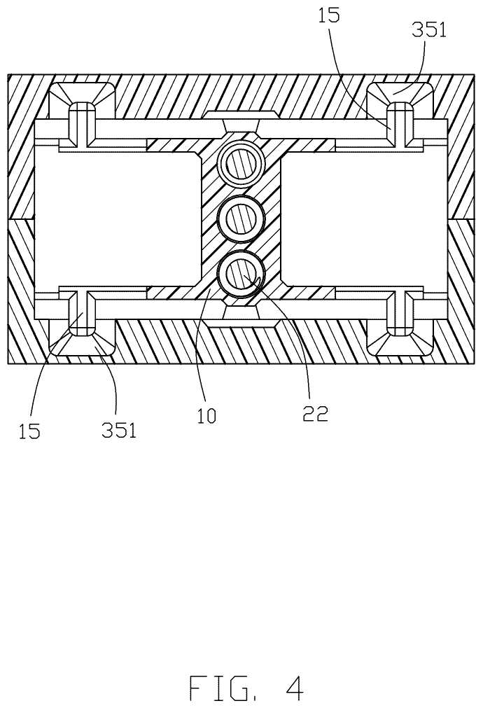

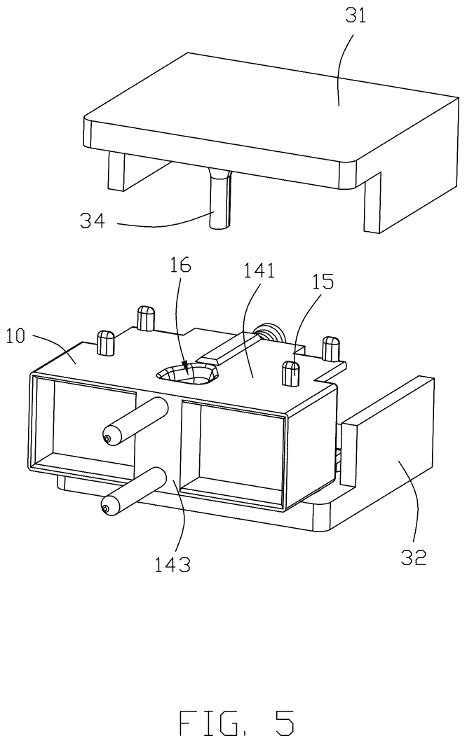

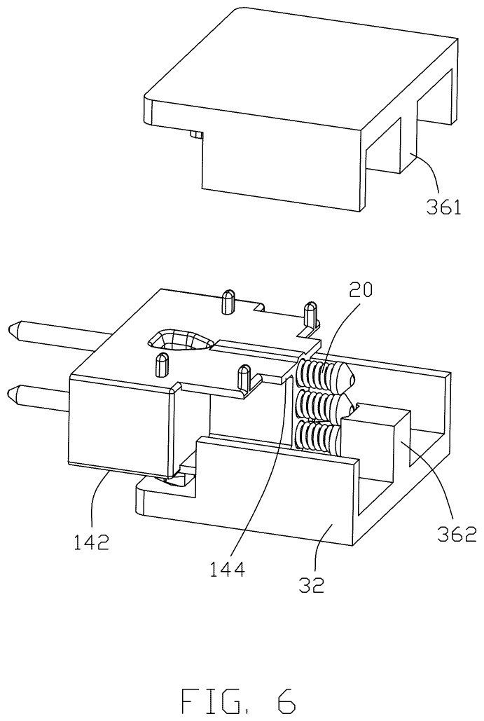

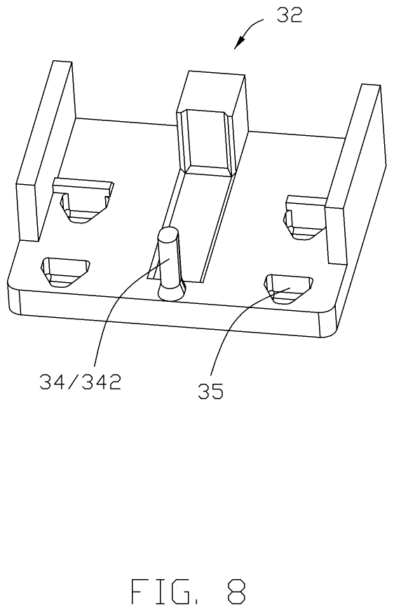

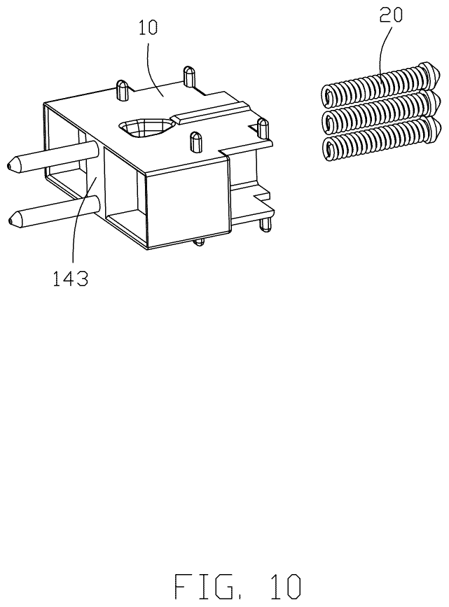

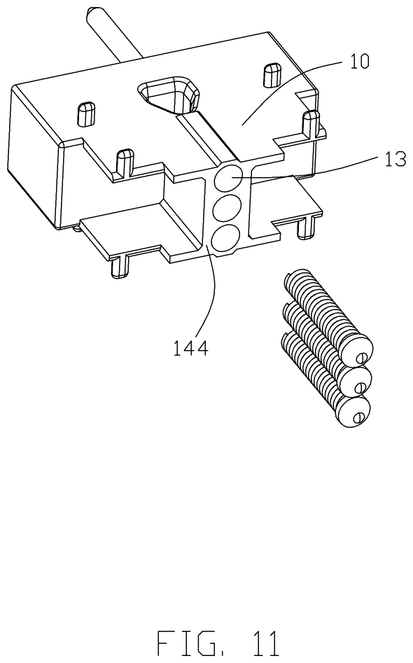

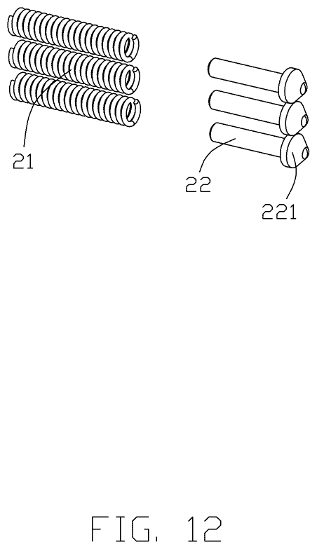

In FIGS. 1-12, the floating assembly 100 is floatingly received between a top base 31 and a bottom base 32 of a device 300, such as a cartridge. The floating assembly 100 includes a metal frame 10 and a spring member 20, the frame 10 has a connector-receiving cavity 11 for fitly receiving a plug connector, such as a backplane which may be connected with cables at a rear end thereof. The plug connector and the receptacle connector can be those in U.S. patent application Ser. No. 19/238,714. That is, the device 300 has a receiving cavity 33 for floatingly receiving the floating assembly 100 and for passing through the cables. The top base 31 and the bottom base 32 commonly define the receiving cavity 33. The top base 31 and the bottom base 32 can be a part of an enclosure of the device 300 or separate from the enclosure of the device. Two guiding pins 12 integrally extend forwards from a front face 143 of the frame 10 for insertion into two guiding holes of a receptacle connector which is mounted on a device such as a switch. The spring member 20 is located behind the frame 10 and blocked by an inside 331 of the receiving cavity 33 as best shown in FIG. 2. When the guiding pins 12 are inserted into the guiding holes, the spring member 20 offers enough force to keep the frame 10 in a front position as shown in FIGS. 3-4. When the plug connector starts to go into the receptacle connector, the frame 10 with the plug connector is driven to move rearwards until the two connectors are mated with each other.

The spring member 20 includes three coil springs 21 and three rods 22 each with a nut 221. As best shown in FIG. 2, the front part of each coil spring 21 is received in a hole 13 defined at the frame 10, the rod 22 is inserted in the rear part of the coil spring 21, the nut 221 press against the inside of the receiving cavity 33. The front end of the coil spring 21 is positioned in a positioning pin 131 in the hole 13. Each of the upper base 31 and the lower base 32 has a stopping portion 361, 362 behind the limiting rods 34, the spring members 20 are pressed against the stopping portions 361, 362. The front faces of the stopping portion defines the inside 331 of the receiving cavity 33.

The frame 10 has a top face 141, a bottom face 142, and a rear face 144. The frame 10 has four guiding rods 15 at each of the top face 141 and the bottom face 142, and a through hole 16 running through the top face 141 and the bottom face 142. The guiding pins 12 are located at substantially a middle portion of the frame, the through hole 16 is located behind the guiding pins 12. Each of the top and bottom bases has a limiting rod 34 and four adjusting caves 35. The limiting rod 34 extends downward/upwards and protrude into the through hole 16. The engagement of the limiting rod 34 and the through hole 16 limits a front position and a rear position of the floating assembly 100. That is, an upper limiting rod 341 extends from the top base 31 and a lower limiting rods 342 extending upwards from the lower base 32, the upper limiting rod 341 and the lower limiting rod 342 protrude into the through hole 16 to limit a movement of the frame in the mating direction X-X in FIG. 1.

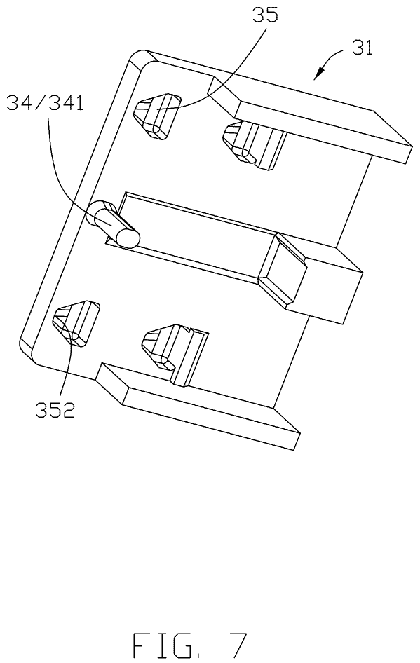

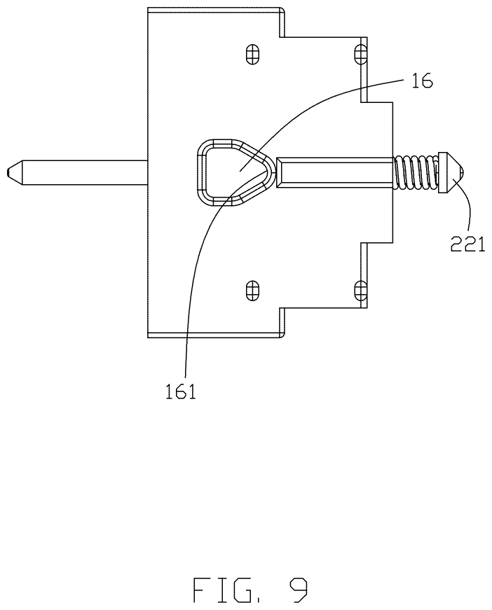

As shown in FIGS. 3-5, each of the caves 35 has a conical inside 351 with ramp surfaces. Each of the caves 35 converges forwards. The through hole 16 converges rearwards. Seen in an upper-lower direction as shown in FIG. 9, the through hole 16 has a conical shape with a rear tip 161 at a rear end thereof. Seen in the upper-lower direction, the cave 35 has a conical shape with a front tip 352 at a front end thereof as best shown in FIG. 7. When the plug connector starts to go into the receptacle connector, the interface of the two connectors offers a further precise alignment and the floating assembly 100 will start a self-alignment by the guiding rods 15 moving along the conical inside 351 by the push of the spring member 20. The frame 10 can shift or float in X, Y, Z axis or three axis, to move the frame 10 back to a central position. Therefore, the centralization of the frame 10 will bring the plug connector to precisely mate with the receptacle connector, thereby achieving a self-returning function.

It is noted that for a connector housing of the plug connector will be disposed therein conductive elements which are omitted in the drawing figures for simplicity and clarity. Similarly, conductive elements disposed in the receptacle connector are omitted in the drawing figures where applicable.

Although the present invention has been described with reference to particular embodiments, it is not to be construed as being limited thereto. Various alterations and modifications can be made to the embodiments without in any way departing from the scope or spirit of the present invention as defined in the appended claims.

1. A floating mechanism comprising:
a receiving cavity and plural caves defined in a device; and
a frame fitly retained with a plug connector which defines a mating direction and pushed to move forwards in the mating direction by a spring member located behind the frame;
wherein the frame has guiding rods, each of the caves has a conical inside, and the guiding rods are capable of shifting along corresponding conical insides of the caves.

2. The floating mechanism as claimed in claim 1, wherein two guiding pins integrally extend forwards from a front face of the frame for insertion into two guiding holes of a receptacle connector.

3. The floating mechanism as claimed in claim 2, wherein:
the frame has a rear face opposite the front face, a top face and a bottom face connecting with the front face and the rear face, and a through hole running through the top face and the bottom face;
the frame has four guiding rods at each of the top face and the bottom face and received in corresponding caves; and
an upper limiting rod extends downwards from the device and a lower limiting rod extends upwards from the device, and the upper limiting rod and the lower limiting rod protrude into the through hole to limit a movement of the frame in the mating direction.

4. The floating mechanism as claimed in claim 3, wherein the through hole is located just behind the guiding pins.

5. The floating mechanism as claimed in claim 3, wherein seen in an upper-lower direction, the through hole has a conical shape with a rear tip at a rear end thereof.

6. The floating mechanism as claimed in claim 5, wherein seen in the upper-lower direction, the cave has a conical shape with a front tip at a front end thereof.

7. The floating mechanism as claimed in claim 1, wherein the device has stopping portions behind the upper limiting rod and the lower limiting rod, and the spring member is pressed against the stopping portions.

8. The floating mechanism as claimed in claim 7, wherein:
the spring member comprises three coil springs and three rods each with a nut; and
a front part of each coil spring is received in a hole defined at the frame, the rod is inserted in a rear part of the coil spring, and the nut presses against the stop portion.

9. A floating mechanism comprising:
a receiving cavity and at least two caves at each of an upper inside and an lower inside of the receiving cavity defined in a cartridge; and
a frame fitly retained with a plug connector defining a mating direction and floatingly received in the receiving cavity and pushed to move forwards in the mating direction by a spring member located behind the frame;
wherein each of the caves has ramp surfaces to converge forwards, the frame has guiding rods, the guiding rods are received in corresponding caves and able to shift along the ramp surfaces of corresponding caves.

10. The floating mechanism as claimed in claim 9, wherein two guiding pins integrally extend forwards from a front face of the frame for insertion into two guiding holes of a receptacle connector.

11. The floating mechanism as claimed in claim 10, wherein:
the frame has a rear face opposite the front face, a top face and a bottom face connecting with the front face and the rear face, and a through hole running through the top face and the bottom face;
the frame has four guiding rods at each of the top face and the bottom face and received in corresponding caves; and
an upper limiting rod extends downward from the upper inside and a lower limiting rod extends upwards from the lower inside of the receiving cavity, and the upper limiting rod and the lower limiting rod protrude into the through hole to limit a movement of the frame in the mating direction.

12. A floating mechanism comprising:
a receiving cavity and a plurality of caves defined in a cartridge; and
a frame fitly retained with a plug connector defining a mating direction and floatingly received in the receiving cavity and pushed to move forwards in the mating direction by a spring member located behind the frame;
wherein the frame has guiding rods received in corresponding caves, and the frame is centered by the guiding pods shifting along the caves during a forward movement of the frame.

13. The floating mechanism as claimed in claim 12, wherein each cave has a conical inside.

14. The floating mechanism as claimed in claim 12, wherein two guiding pins integrally extend forwards from a front face of the frame for insertion into two guiding holes of a receptacle connector.
